(19) United States
(12) Patent Application Publication
(10) Pub. No.: US 2012/0193191 A1
(43) Pub. Date: Aug. 2, 2012

(54) DEVICE AND METHOD FOR GROUPING PIECE GOODS

(76) Inventor: Robert Hefti, Weesen (CH)

(21) Appl. No.: 13/386,038

(22) PCT Filed: Jul. 16, 2010
(86) PCT No.: PCT/IB2010/053263

§ 371 Date: Jan. 20, 2012

(30) Foreign Application Priority Data
Jul. 24, 2009 (CH) 01165/09

(51) Int. Cl. B65G 47/30

(52) U.S. Cl. 198/418; 198/617

(57) ABSTRACT

A transfer wheel for grouping rod-shaped or tubular objects is disclosed, consisting of at least two segments (1), (2) that can be controlled independently of each other. The segments are filled in a cyclic operation by way of a toothed belt (5) filled with the objects, wherein missing objects (gaps) on the toothed belt (5) are skipped, so that each segment (1) is completely filled with the objects. The filled segment (2) is rotated with fast advancement to the dispensing wheel (4), to which the grouped objects are dispensed again. The segments (1), (2) alternately pick up and dispense the objects.

The invention relates to an apparatus and a method for grouping of objects according to the preamble of claim 1, respectively 6. The method is particularly suited to group rod-shaped or tubular articles, called “objects” here on forth.

Devices to group rod-shaped or tubular objects of claim 1 are known. To gain a high standard in product quality, it is necessary to control and remove objects individually of in multiples from the process. For this, a need exists for an apparatus and method to efficiently regroup objects. Subsequently, this apparatus or method allows to present objects in the correct arrangement and correct count to the next manufacturing process.

Known methods of grouping objects generally require a reduction in manufacturing speed. This is because grouped objects can only be passed on to the next process steps after gaps of the removed, faulty objects have been filled again with good quality objects. Furthermore, the overall process speed to pass on grouped objects to the next manufacturing steps is slower and often not uniform due to inconsistent gaps of previously removed, faulty objects.

The invention addresses the task to create an apparatus and a method for grouping rod-shaped or tubular objects by introducing a transfer wheel. The transfer wheel significantly increases the overall production speed by bridging the fast feed rate of individual objects into the transfer and the delivery speed of the grouped objects out of the transfer to the next process step.

This objective is achieved by a transfer wheel with the features of claim 1, and a method for delivering objects to the next process step with the features of claim 6. Additional inventive features will become apparent from the dependent claims and their advantages are explained in the following description.

The drawings illustrate:

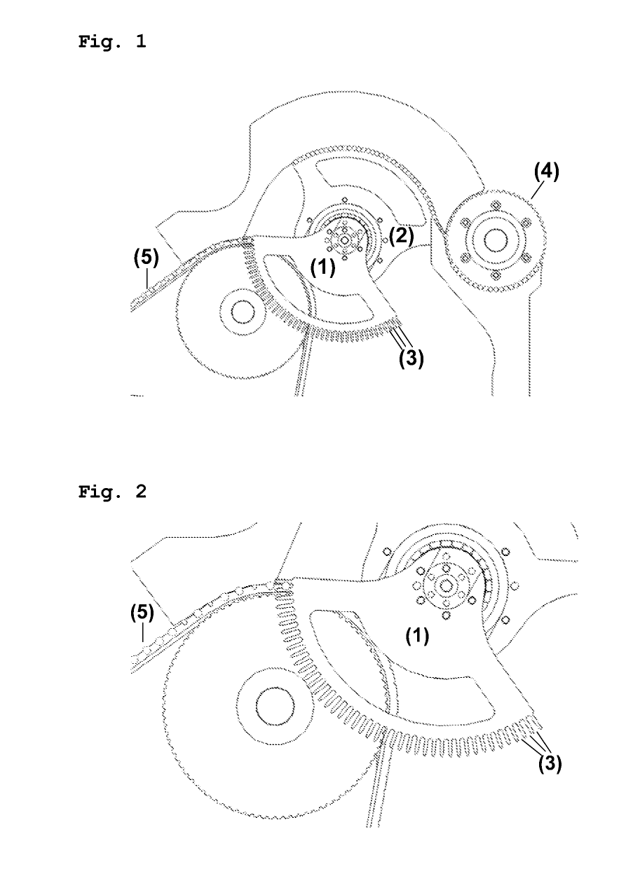

FIG. 1 Transfer wheel with 2 segments

FIG. 2 Transfer wheel, one segment receiving single objects

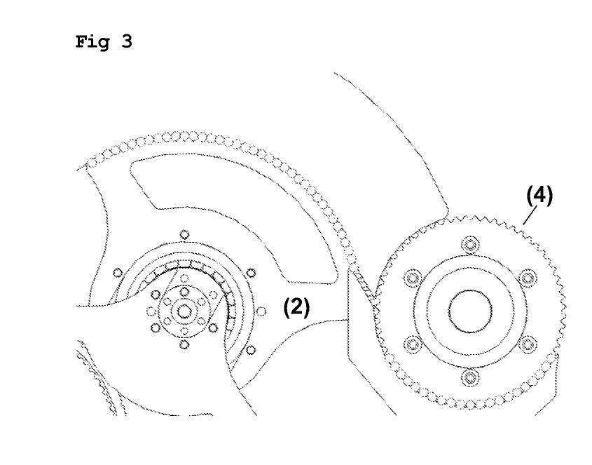

FIG. 3 Transfer wheel, one segment at the transfer of grouped objects

The sketches represent preferred exemplary proposals. They are explained in the description below.

In FIG. 1 the transfer wheel shown, consists of two segments (1) and (2). This transfer wheel is located between the profile belt (5), which supplies individual objects and the Takeover wheel (4), which feeds the grouped objects to the next process step.

As shown in FIG. 2, the rod-shaped or tubular objects are supplied via a profile belt (5). Each position of the belt (5) contains either an object or presents a gap. The segment (1) contains a predefined number of receiving spaces (3). Each reception space is designed for the inclusion of exactly one object. The segment (1) will now be filled by the supply of objects from belt (5). The segment (1) rotates to the next position each time an object has been placed into a reception space. The rotation of the segment (1) is made possible by a servo drive. This servo drive is exclusively moving segment (1). Segment (2) has its own independent servo drive.

Segment (1) is continuously filled with single objects. As soon as the last receiving space (3) of the segment (1) has been filled, segment (1) rotates rapidly to the next transfer position at the takeover wheel (4).

FIG. 3 shows the rotated segment (2) transferring a full set of rod-shaped or tubular objects to the takeover wheel (4). The takeover wheel will then feed the grouped objects to the next process step.

As soon as all objects have transferred from segment (2) to takeover wheel (4), segment (2) is moved rapidly back to the belt (5), for the renewed receiving of single objects.

### List of References

(1) First Segment of Transfer Wheel
(2) Second Segment of Transfer Wheel
(3) Receiving Space for Individual Objects
(4) Takeover wheel
(5) Profile Belt

1. Transfer wheel for the grouping of consistently fed rod-shaped or tubular objects with intermittent gaps into groups of objects without gaps, wherein said transfer wheel consists of at least two independently controlled segments (1), (2), each segment receives the individual objects delivered and transfers objects in complete groups to the next process step.

2. Transfer wheel according to claim 1, wherein each segment has an independent servo drive.

3. Transfer wheel as described in claim 1 or 2, wherein said transfer wheel has the ability to receive and group objects with a speed of up to 4,000 pieces per minute.

4. Transfer wheel according to claims 1 to 3, wherein the ratio between the speed of the grouped transition and the speed of the received objects is between 1.2 and 1.5.

5. Transfer wheel according to claims 1 to 4, wherein the time to fast forward or rewind the segments is within the range of 25 to 250 milliseconds and the time is less than half the difference between the time to completely fill a segment (1) and the time to empty a segment (2).

6. Method for grouping of rod-shaped or tubular objects comprising of steps:
Receiving individual objects into a segment (1) of a transfer wheel in a cyclic motion
Rapid rotation of a segment (2) filled with grouped objects to the delivery point
Transfer of the grouped objects to the next process is synchronized with the task of receiving individual objects in such a way that an empty segment (1) is ready to receive individual objects when segment (2) is completely filled and ready to be moved to the transfer point at the takeover wheel (4).
